(19) United States
(12) Patent Application Publication
(10) Pub. No.: US 2022/0300964 A1
(43) Pub. Date: Sep. 22, 2022

(54) SYSTEMS AND METHODS FOR BLOCKCHAIN-BASED ESCROW MANAGEMENT

(71) Applicant: RoeketBC, Limited, Mid-Levels (HK)

(72) Inventor: Sungjae Chung, Stamford, CT (US)

(21) Appl. No.: 17/204,710

(22) Filed: Mar. 17, 2021

(51) Int. Cl. G06Q 20/40; G06Q 20/38; G06Q 40/04

(52) U.S. Cl. CPC G06Q 20/401; G06Q 20/389; G06Q 40/04; G06Q 20/3825; G06Q 2220/00

(57) ABSTRACT

Systems and methods are disclosed for verifying and processing financial transactions. In certain embodiments, the techniques involve receiving transaction data corresponding to a financial transaction from a sender and detecting and verifying transaction terms from the transaction data. The system then receives a second set of transaction data corresponding to the financial transaction from a receiver and verifying that the first set of transaction data corresponds to the second set of transaction data. Based on that verification, the system initiates the transfer of cryptocurrency or other digital assets associated with the financial transaction.

### FIELD OF THE INVENTION

The present invention is directed systems and methods directed to trading systems. More specifically, the present invention is directed to a non-custodial blockchain based escrow system for peer-to-peer transactions.

### BACKGROUND OF THE INVENTION

Traditional escrows consist of a trusted middleman or broker that holds the funds during the trade. In the field of cryptocurrency (also referred to herein as “crypto” or “cryptos”), once funds are with this third party, it can technically do whatever it wants with them. For example, the party could transfer it out somewhere else, or even withhold your funds for any reason. On the other hand, there have been cases where the third party gets hacked and/or loses the funds forever. To date, there has been no technology built that is a truly non-custodial, on-chain escrow system that works with several different major blockchain protocols.

Currently, many different centralized service providers (such as centralized crypto spot exchanges and peer-to-peer exchanges) use custodial hot wallets that they manage for their users. In order to use these services, users need to deposit their crypto into these custodial wallets, owned by a centralized party. Users need to pay the transaction fees associated with depositing and later withdrawing their cryptos from these exchanges.

Furthermore, since the centralized service providers own these custodial hot wallets, they can technically use those funds at their own discretion. They also withhold or block withdrawals at times, and if the service shuts down, the user may lose their funds forever.

As such, there is a need in the art for a system that eliminates the need to deposit or withdraw funds to or from a trusted third party and provides a secure and easy way to settle crypto-based trades.

### SUMMARY OF THE INVENTION

By using this system, neither the crypto sender nor receiver needs to spend the time and transaction fees to deposit and withdraw their funds. Furthermore, by using the system of the present invention, users do not need to rely on trusting who they are dealing with and/or trust a centralized third party with their funds. Finally, those that utilize this system can make crypto based deals with other people, institutions, businesses, and/or asset managers directly, in a secure and non-custodial manner.

In certain embodiments, the present invention comprises: a server comprising a smart contract module that receives a first set of transaction data corresponding to the financial transaction from a sender, detects and verifies transaction terms from the first set of transaction data, receives a second set of transaction data corresponding to the financial transaction from a receiver, verifies that the first set of transaction data corresponds to the second set of transaction data, and initiates the transfer of cryptocurrency associated with the financial transaction.

In other embodiments, the present invention comprises: a server comprised of: a multi-signature address module that operates to settle disputes between a sender and a receiver involved in a financial transaction, wherein the multi-signature address module receives a first set of transaction data corresponding to the financial transaction from a sender, wherein the first set of transaction data is comprised of a first signed key, detects and verifies transaction terms from the first set of transaction data, signs the verified transaction data with a second signed key, and opens the financial transaction for processing, wherein the server initiates the transfer to cryptocurrency associated with the open financial transaction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary embodiment of the hardware of the system of the present invention;

FIG. 2A shows a software flow of an exemplary embodiment of the invention where there is an open trade on a smart contract;

FIG. 2B shows a software flow of an exemplary embodiment of the invention where escrow is funded on a smart contract;

FIG. 2C shows a software flow of an exemplary embodiment of the invention where there is an attempt to cancel an open trade or issue a refund on a smart contract;

FIG. 2D shows a software flow of an exemplary embodiment of the invention where there is an attempt to release escrow on a smart contract;

FIG. 2E shows the software flow if there is a dispute during an exemplary transaction using smart contracts;

FIG. 3A shows a software flow of an exemplary embodiment of the invention where there is an open trade using the multi-signature address technique;

FIG. 3B shows a software flow of an exemplary embodiment of the invention where escrow is funded using the multi-signature address technique;

FIG. 3C shows a software flow of an exemplary embodiment of the invention where there is an attempt to cancel an open trade or issue a refund using the multi-signature address technique;

FIG. 3D shows a software flow of an exemplary embodiment of the invention where there is an attempt to release escrow using the multi-signature address technique;

FIG. 3E shows the software flow if there is a dispute during an exemplary transaction using the multi-signature address technique;

FIG. 4 shows an exemplary diagram of the system processes using smart contract escrows; and

FIG. 5 shows an exemplary diagram of the system processes using multi-signature (on-chain) escrows.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

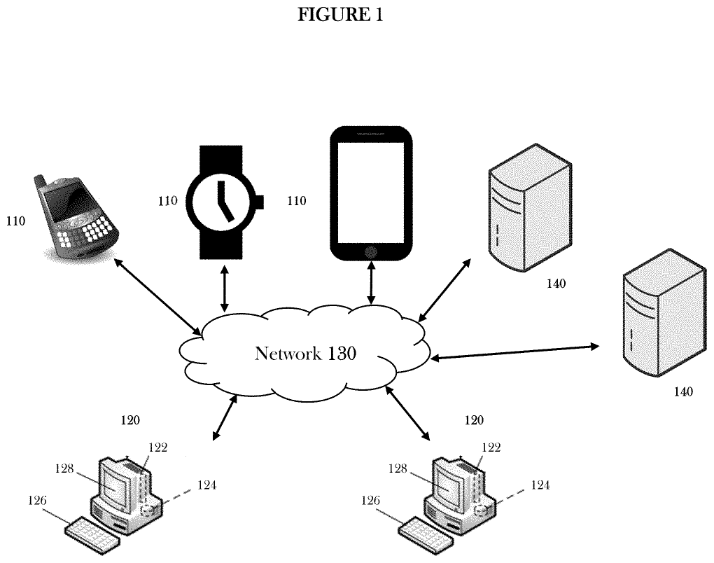

FIG. 1 is an exemplary embodiment of the system of the present invention. In the exemplary system 100, one or more peripheral devices 110 are connected to one or more computers 120 through a network 130. Examples of peripheral devices/locations 110 include smartphones, tablets, wearables devices, and any other electronic devices that collect and transmit data over a network that are known in the art. The network 130 may be a wide-area network, like the Internet, or a local area network, like an intranet. Because of the network 130, the physical location of the peripheral devices 110 and the computers 120 has no effect on the functionality of the hardware and software of the invention. Both implementations are described herein, and unless specified, it is contemplated that the peripheral devices/locations 110 and the computers 120 may be in the same or in different physical locations. Communication between the hardware of the system may be accomplished in numerous known ways, for example using network connectivity components such as a modem or Ethernet adapter. The peripheral devices/locations 110 and the computers 120 will both include or be attached to communication equipment. Communications are contemplated as occurring through industry-standard protocols such as HTTP or HTTPS.

Each computer 120 is comprised of a central processing unit 122, a storage medium 124, a user-input device 126, and a display 128. Examples of computers that may be used are: commercially available personal computers, open source computing devices (e.g. Raspberry Pi), commercially available servers, and commercially available portable device (e.g. smartphones, smartwatches, tablets). In one embodiment, each of the peripheral devices 110 and each of the computers 120 of the system may have software related to the system installed on it. In such an embodiment, system data may be stored locally on the networked computers 120 or alternately, on one or more remote servers 140 that are accessible to any of the peripheral devices 110 or the networked computers 120 through a network 130. In alternate embodiments, the software runs as an application on the peripheral devices 110.

The system is designed to be used by two parties, crypto sender and crypto receiver, who agree on some sort of a deal. An example of an application is a fiat-crypto trade, where the crypto sender is selling 1 BTC for 10 USD. They would use the escrow system to trade directly with each other trustlessly. Another example would be when the crypto receiver is a service provider, who wants to receive payment for their services in crypto through this non-custodial escrow system. In the case of the present invention, two types of non-custodial escrow systems compatible with multiple blockchain protocols have been developed, including but not limited to Bitcoin, Ethereum, EOS.IO, Tron, Binance Chain, and Solana.

The first type uses smart contract-based escrows, which are blockchain addresses that have smart contracts (autonomous code that runs on chain) deployed on them. This system only works on blockchain networks that are run using protocols that support smart contracts, such as Ethereum, EOS.IO, Tron, and Solana. The smart contract-based system makes it possible to run transactions autonomously, without having an absolute owner to the cryptocurrencies involved in the transaction at any one point.

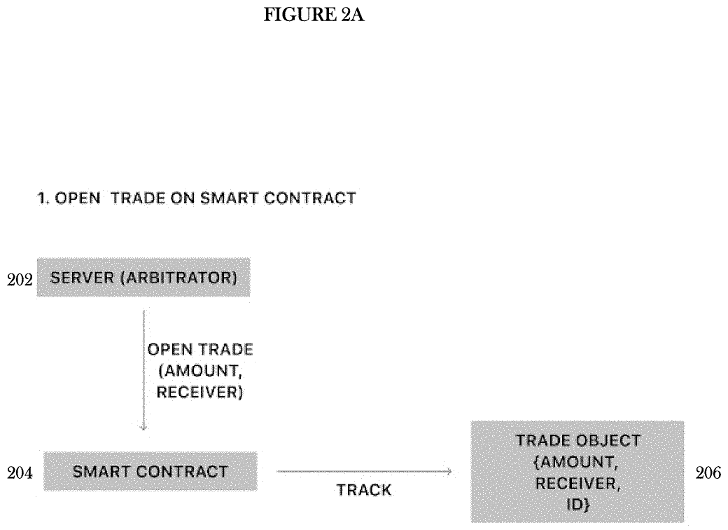

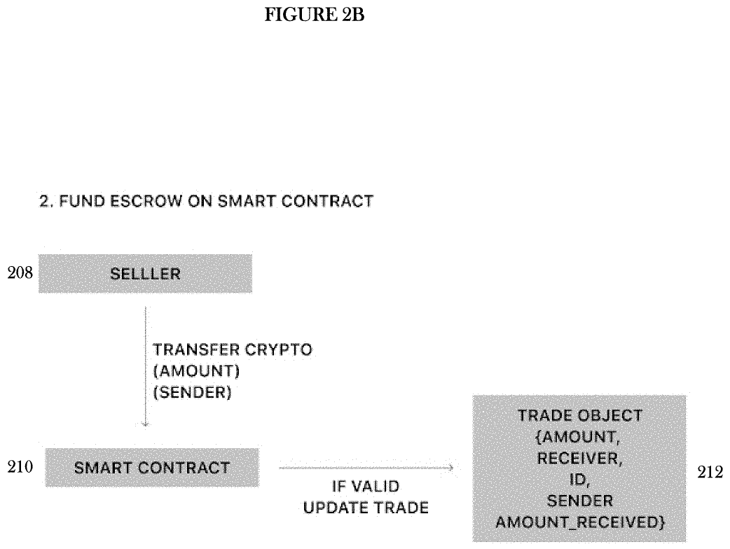

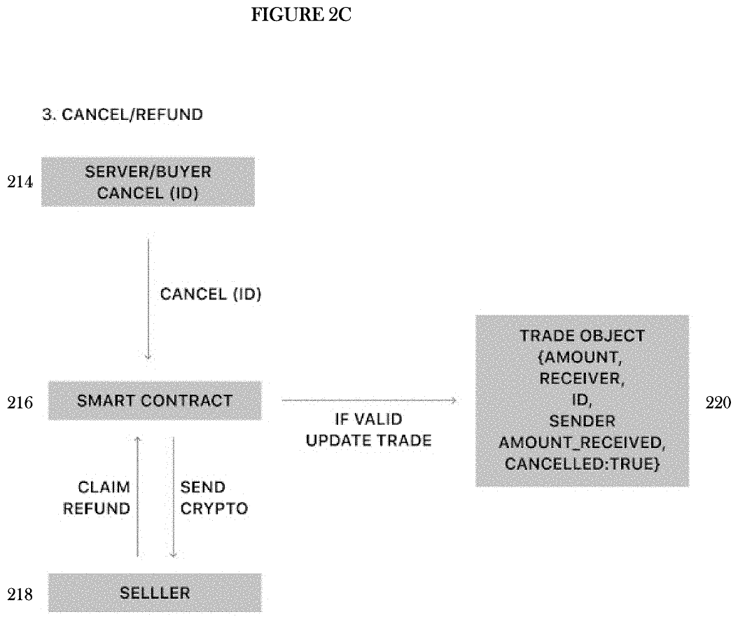

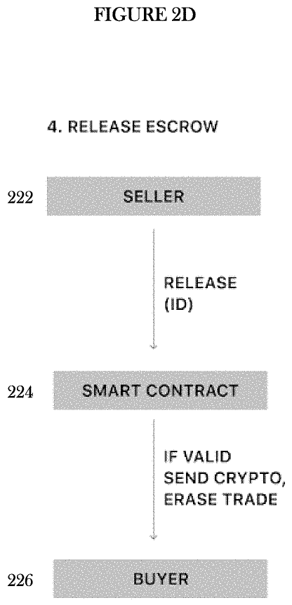

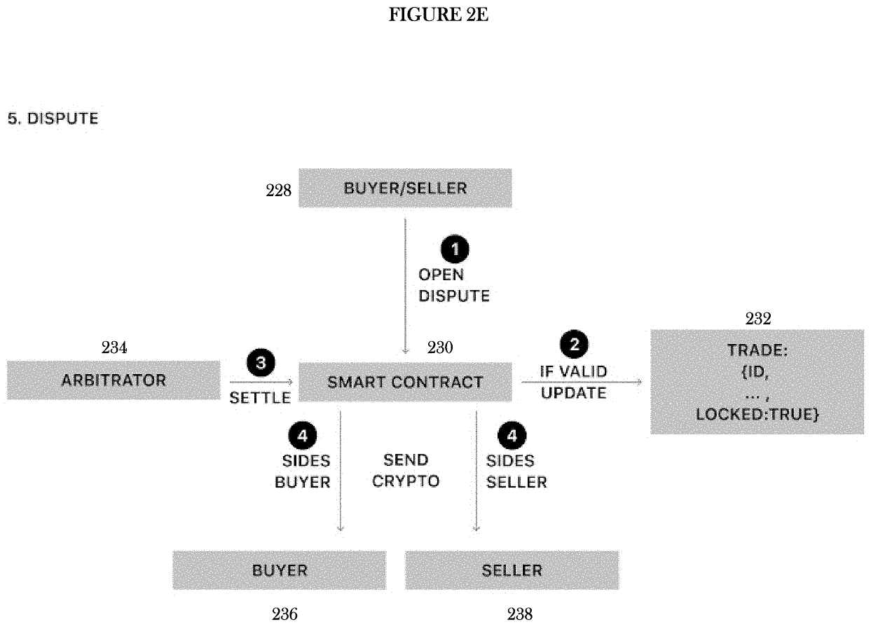

FIG. 2A shows a software flow of an exemplary embodiment of the invention where there is an open trade on a smart contract. In the system of the present invention, a server/arbitrator 202 is set, which can help settle any disputes that may occur between the parties involved during a transaction, for example, an open trade, where there is an amount and a receiver identified. At the beginning of each transaction, the crypto sender and receiver agree on the terms of the deal. Once the transaction is open, the smart contract 204 automatically detects and confirms when it receives from the sender the correct amount of cryptocurrency that was agreed upon for the transaction. Smart contracts are autonomous pieces of code/software that run on blockchain. The smart contract escrow of the present invention has been designed specifically to monitor for incoming transfers. It does this by creating trade objects in a multi-index table that tracks the variables needed for the non-custodial P2P trading system of the present invention. Whenever there is a token transfer with a destination address set to the smart contract escrow, along with the coinciding trade's ID as its memo, the smart contract modifies its data state within the multi-index table. In certain embodiments, it modifies the “Sender” variable with the sender account of the transaction, and amount_received with the amount of tokens received. The servers (off-chain) simply read the smart contract data state continuously, looking for updates, and broadcast certain changes to the user through the web frontend. Specifically, when the server sees that the trade object coinciding with the ID of the trade that the user is part of has amount_received greater or equal to the amount of the trade, it can confirm to the user that the escrow has been funded. The traders (users) can verify this information themselves by looking at the on-chain smart contract data.

Once the smart contract 204 confirms that it has received the correct amount, the crypto receiver can then provide their side of the deal. Using the examples above, this could be a 10 USD bank transfer directly to the crypto sender's bank account, or it may be that the crypto receiver provides some sort of a service for the sender (based on their agreement). Other non-limiting examples could be the sale of an asset (e.g. real estate, car, boat) or non-fungible tokens (NFTs). Once this side of the transaction is complete, the sender can authorize the smart contract-based escrow to release the cryptos to the receiver. When both parties indicate that they agreed on terms on the off-chain servers, the servers query the smart contract to open a new trade on chain. An open trade is comprised of trade object data 206. Trade object data 206 is comprised of such values as the amount, the receiver, the trade ID, the sender, and the amount received. The trade ID is preferably a unique trade ID generated by the smart contract code.

FIG. 2B shows a software flow of an exemplary embodiment of the invention where escrow is funded on a smart contract. In that scenario, the seller 208 will perform a transaction where there is a transfer of cryptocurrency, which includes data identifying the amount and the sender. The smart contract 210 automatically detects and confirms when it receives from the sender the correct amount of cryptocurrency that was agreed upon for the escrow transaction.

The smart contract escrow of the present invention has been designed specifically to monitor for incoming transfers. It does this by creating trade objects in a multi-index table that tracks the variables needed for the non-custodial P2P trading system of the present invention. Whenever there is a token transfer with a destination address set to the smart contract escrow, along with the coinciding trade's ID as its memo, the smart contract modifies its data state within the multi-index table. In certain embodiments, it modifies the “Sender” variable with the sender account of the transaction, and amount_received with the amount of tokens received. The servers (off-chain) simply read the smart contract data state continuously, looking for updates, and broadcast certain changes to the user through the web frontend. Specifically, when the server sees that the trade object coinciding with the ID of the trade that the user is part of has amount_received greater or equal to the amount of the trade, it can confirm to the user that the escrow has been funded. The traders (users) can verify this information themselves by looking at the on-chain smart contract data.

If the escrow transaction is found to be valid, the open trade is updated, where open trade is comprised of trade object data 212. Trade object data 212 is comprised of such values as the amount, the receiver, the trade ID, the sender, and the amount received.

FIG. 2C shows a software flow of an exemplary embodiment of the invention where there is an attempt to cancel an open trade or issue a refund on a smart contract. In this scenario, the server/buyer 214 transmits a cancellation transaction, where the transaction is comprised of a cancellation request and the transaction ID. The smart contract 216 automatically detects and confirms when it receives valid information to cancel an open trade or issue a refund on a smart contract.

The smart contracts have been designed to iterate through the multi-index table of trade objects, looking for an ID that coincides with the ID given in the “cancel” function. If the cancelled status of the trade object found is already pointing to true, the transaction reverts. The smart contracts also check that the sender of the transaction was the buyer. They do this by requiring the authority of the buyer's key and validating that the transaction signature has the correct authority. Finally, for the “cancel” function, the smart contract code verifies that amount_received is 0. Otherwise, the seller must claim their refund. If any of the checks within the smart contract code mentioned above fail, the transaction simply gets reverted, and the smart contract data state remains unchanged. If the cancel function goes through, the trade object's cancelled status is modified to true.

Refund transactions work similarly. The smart contract code iterates through the multi-index table and looks for a trade object that has its Sender variable coinciding with the seller's address that they used to sign the transaction. If there is a match, the smart contract code checks that the cancelled status is not yet true. Then, it modifies the cancelled status to true and creates and pushes a transaction that sends the crypto coinciding to the amount_received to the seller's account. If any of the checks above fail, the transaction reverts and the smart contract data remains unchanged.

If the smart contract 216 determines that a refund should be issued, the cryptocurrency will be sent to the seller 218. If the smart contract 216 determines that an open trade should be updated, it transmits those instructions to the trade object 220. The trade object 220 is comprised of such values as the amount, the received, the trade ID, the amount received, and a cancellation value that reflects the status of the trade.

FIG. 2D shows a software flow of an exemplary embodiment of the invention where there is an attempt to release escrow on a smart contract. In this scenario, the seller 222 transmits an instruction to release escrow to the smart contract 224, where the instruction is preferably comprised of the trade ID. The smart contract 224 automatically detects and confirms whether the release instruction for the escrow is valid. The smart contracts have been designed to iterate through the multi-index table of trade objects, looking for an ID that coincides with the ID given in the release escrow function. It then checks that the trade objects amount_received is greater or equal to the trade amount. They also check that the sender of the transaction was the seller. They do this by requiring the authority of the seller's key and validating that the transaction signature has the correct authority. If all of the above checks pass, the smart contract code constructs a transaction that releases the trade amount's crypto to the buyer's address (receiver account). It then erases the completed trade by removing the object for that trade ID completely.

If it determines that instruction is valid, cryptocurrency corresponding to the transaction is sent to the buyer 226 and the trade is erased. When the trade is erased, it means that the trade object for the corresponding trade ID on the multi-index table of the smart contract gets erased. There is no reason to track the trade further once the trade is completed, so it is deleted from the multi-index table to conserve RAM. If the attempt to release the escrow is determined to be invalid, the transaction on chain simply reverts and the user must perform the transaction correctly. The web frontend shows corresponding error feedback to the user to guide them, as well.

FIG. 2E shows the software flow if there is a dispute during an exemplary transaction using smart contracts. In that case, the smart contract's 230 preset arbitrator 234 can help resolve the dispute. The arbitrator 234 is someone that owns the blockchain address on the smart contract 230 (specified before the transaction) that can help arbitrate disputes if and only if there is a dispute triggered by either the sender or the receiver. An example of such a situation would be if the receiver does not fulfill his/her side of the deal, or if the sender refuses to release the cryptocurrency in the smart contract even though the deal was fulfilled. In this case, the arbitrator can compile the data from both parties, and release the cryptos associated with the transaction in the smart contract escrow to either the sender's blockchain address 236 or the receiver's blockchain address 238. The arbitrator 234 can never pull the funds out elsewhere and can make no impact on the transaction unless a dispute arises.

The arbitrator 234 communicates with the traders (users) through the web frontend. Since the crypto is locked in the escrow during any dispute, the only part in question is whether the payment was made or not. The seller is asked to provide proof of funds received, and the buyer is asked to provide proof of funds sent. The backend servers also track the reputation of each user based on number of successful trades (undisputed) and volume. With this data, the arbitrator can decide on to whom the funds should be released. Using the technology of the present invention, users are guaranteed that the funds cannot slip elsewhere. By design, the arbitrator's 234 role is only to be able to side with one side: buyer or seller. This keeps the system more secure from outside hacks trying to pull the funds out elsewhere. Specific payment methods such as PayPal, KakaoPay, WeChat Pay, and/or USDT settlement have nuances to check for that makes it easier to determine the source of truth. Arbitrators 234 in the present system know what to look for based on the payment method.

The second type of implementation of the system uses multi-signature blockchain addresses and can be applied on all of the blockchain networks supported by any of the protocols mentioned above. Some blockchains do not natively support smart contracts, which is why multi-signature addresses are used as the escrows instead.

For this alternate embodiment, new, unique multi-signature escrows are generated at the beginning of each transaction. The multi-signature escrow is generated so that there are a total of three signing keys, and the escrow can only transfer its cryptos if and only if there are at least two out of the three keys that approve and sign that transfer. One signing key is given to the crypto sender, one is given to the receiver, and one is held by the arbitrator(s). The rest of the steps for the transaction is similar to the smart contract-based escrow system explained above. The multi-signature address detects when the correct amount of cryptos has been sent by the crypto sender, and the receiver is expected to fulfill their side of the deal. If the deal had no issues, the sender and receiver agree to release the cryptos to the receiver. These two parties on their own meet the two of three multi-signature requirements, so the transaction can be completed without the need for an arbitrator.

The distribution and management of keys in the present invention improves on conventional systems. In the present system, a backend server encrypts the buyer and seller's keys with easy, human keys (passwords) provided by the user. The servers only store the encrypted keys. As a result, the user does not have to copy a private key anywhere or learn how to sign transactions themselves. The servers perform the encryption for the users, and when the users need to release the funds from the escrow, they simply provide their password so that the servers can decrypt and help them sign the transaction.

If there is a dispute between the two parties, the arbitrator can compile the data and sign the transfer with the correct side (transfer the crypto to the sender if the receiver is in the wrong, or release the crypto to the receiver if the sender is in the wrong). This will fulfill the two of three multi-signature requirements needed to transfer the cryptos in the escrow and complete the transaction. Since the arbitrator only has one of three keys, the arbitrator never takes custody of the cryptos at any time and cannot transfer the cryptos out to some other blockchain addresses.

As explained above, the arbitrator 234 communicates with the traders (users) through the web frontend. Since the crypto is locked in the escrow during any dispute, the only part in question is whether the payment was made or not. The seller is asked to provide proof of funds received, and the buyer is asked to provide proof of funds sent. The backend servers also track the reputation of each user based on number of successful trades (undisputed) and volume. With this data, the arbitrator can decide on to whom the funds should be released. Using the technology of the present invention, users are guaranteed that the funds cannot slip elsewhere. By design, the arbitrator's 234 role is only to be able to side with one side: buyer or seller. This keeps the system more secure from outside hacks trying to pull the funds out elsewhere. Specific payment methods such as PayPal, KakaoPay, WeChat Pay, and/or USDT settlement have nuances to check for that makes it easier to determine the source of truth.

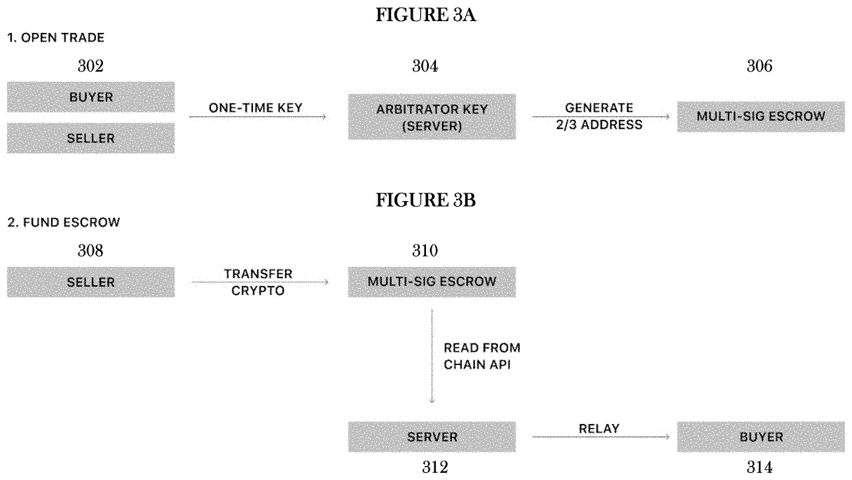

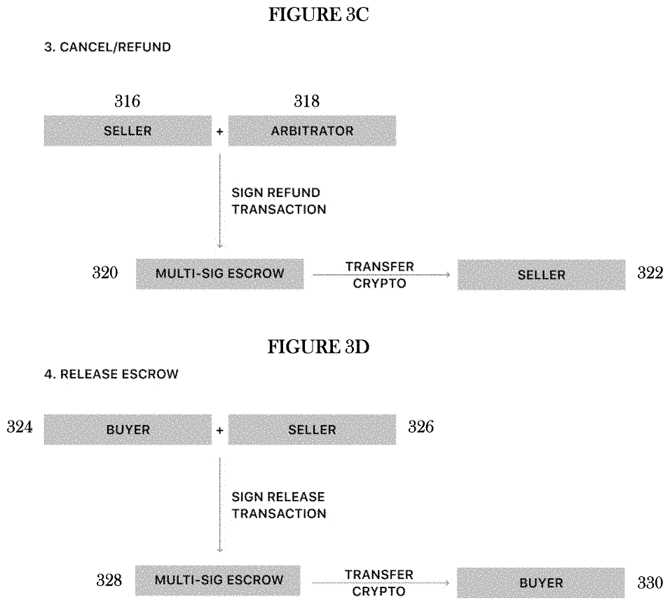

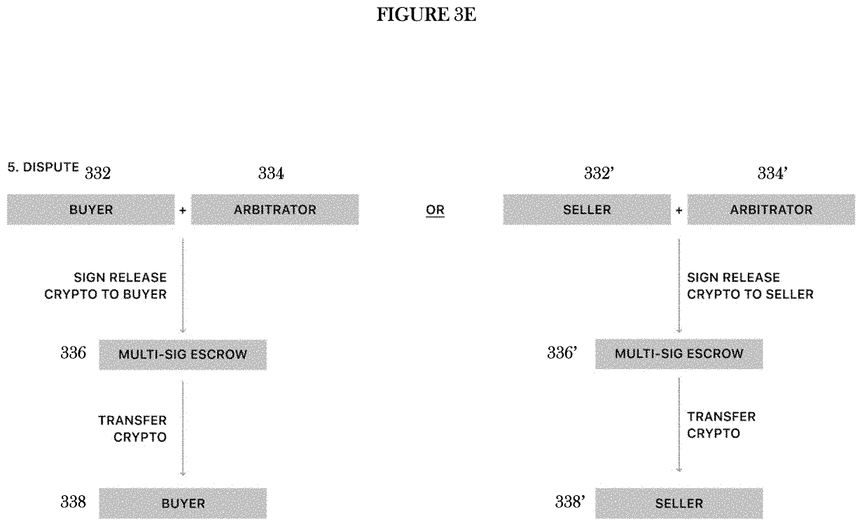

FIG. 3A shows a software flow of an exemplary embodiment of the invention where there is an open trade using the multi-signature address technique. In the system of the present invention, at the beginning of each transaction, the crypto buyer and seller 302 agree on the terms of the deal. One or more of the buyer or seller 302 transmits a one-time key to the server/arbitrator 304, which has its own key. The server/arbitrator 304 approves and signs the open trade with its own key, such that two out of three keys are signed to the transaction. Once the transaction is open, the multi-signature escrow 306 detects and confirms when it receives from the sender the correct amount of cryptocurrency that was agreed upon for the transaction. Detection and confirmation occur when the multi-signature escrow 306 itself receives the crypto, and the off-chain servers read the on-chain transactions in order to determine whether the specific escrow for that trade has been funded. Because the servers generated the multi-signature escrow 306 when the trade was created, a centralized database saves the multi-signature escrow's 306 address and continues to monitor transactions to it when the seller is funding it with crypto. Backend servers also ensure that any transaction of crypto funding the escrow gets at least 3-6 block confirmations before giving the user full confirmation on the web frontend. This is because transactions that have not been confirmed by enough blocks may get forked and lost when blockchain networks are unstable. Once the multi-signature escrow 306 confirms that it has received the correct amount, the crypto receiver can then provide their side of the deal.

FIG. 3B shows a software flow of an exemplary embodiment of the invention where escrow is funded using the multi-signature address technique. In that scenario, the seller 308 will perform a transaction where there is a transfer of cryptocurrency, which includes data identifying the amount and the sender. The multi-signature escrow 310 detects and confirms when it receives from the sender the correct amount of cryptocurrency that was agreed upon for the escrow transaction. Detection and confirmation occur when the multi-signature escrow 310 itself receives the crypto, and the off-chain servers read the on-chain transactions in order to determine whether the specific escrow for that trade has been funded. Because the servers generated the multi-signature escrow 310 when the trade was created, a centralized database saves the multi-signature escrow's 310 address and continues to monitor transactions to it when the seller is funding it with crypto. Backend servers also ensure that any transaction of crypto funding the escrow gets at least 3-6 block confirmations before giving the user full confirmation on the web frontend. This is because transactions that have not been confirmed by enough blocks may get forked and lost when blockchain networks are unstable. Once the multi-signature escrow 310 confirms that it has received the correct amount, the crypto receiver can then provide their side of the deal. If the escrow transaction is found to be valid, the open trade is updated and transmitted to the server 312, where the transaction is preferably read from Chain API. The data from the servers is read using the chainAPI to perform a get Transactions call (or whatever the “get transactions” function is called for the specific blockchain) and ensure that the transactions have been fully confirmed. The escrow funding is then relayed from the server 312 to the buyer 314.

FIG. 3C shows a software flow of an exemplary embodiment of the invention where there is an attempt to cancel an open trade or issue a refund using the multi-signature address technique. In this scenario, the seller 316 and the arbitrator 318 sign and transmits a cancellation or refund transaction to the multi-signature escrow 320, where the transaction is comprised of a cancellation or refund request and the transaction ID. The multi-signature escrow 320 detects and confirms when it receives valid information to cancel an open trade or issue a refund. The multi-signature escrows 320 (addresses) only require two of the three signatures to trigger a transaction. For a cancel/refund, the seller 316 simply provides their encryption key (password) for their share of the multi-signature escrow key, and the server (which holds the arbitrator key) also signs the transaction. The transaction will be constructed by the backend servers so that the seller's address is set as the recipient of the crypto corresponding to the multi-signature escrows balance. If the multi-signature escrow 320 determines that a refund should be issued, the cryptocurrency will be sent to the seller 322.

FIG. 3D shows a software flow of an exemplary embodiment of the invention where there is an attempt to release escrow using the multi-signature address technique. In this scenario, the buyer 324 and the seller 326 sign a release transaction and transmit an instruction to release escrow to the multi-signature escrow 328, where the instruction is preferably comprised of the trade ID. The multi-signature escrow 328 detects and confirms whether the release instruction for the escrow is valid. The multi-signature escrows 328 (addresses) only require two of the three signatures to trigger a transaction. For release escrow, the seller simply provides their encryption key (password) for their share of the multi-signature escrow key, and the server (which holds the arbitrator key) also signs the transaction. The transaction will be constructed by our backend servers so that the buyer's address is set as the recipient of the crypto corresponding to the trade amount. If it determines that instruction is valid, cryptocurrency corresponding to the transaction is sent to the buyer 330. If the attempt to release the escrow is determined to be invalid (i.e. the multi-sig transaction signature was invalid), the transaction never gets confirmed by the validators of the blockchain network and therefore gets reverted. When the transaction is complete, the multi-signature escrow is empty (since it transferred out the crypto) and will no longer be in use.

FIG. 3E shows the software flow if there is a dispute during an exemplary transaction using the multi-signature address technique. In this scenario, the buyer 332 and the arbitrator 334 sign and release crypto to the buyer 338 or the seller 332′ and the arbitrator 334′ sign and release crypto to the seller 338′. In both cases, the arbitrator 334, 334′ can help resolve the dispute. The arbitrator 334, 334′ can help arbitrate disputes if and only if there is a dispute triggered by either the buyer 332 or the seller 332′. An example of such a situation would be if the receiver does not fulfill his/her side of the deal, or if the sender refuses to release the cryptocurrency in the smart contract even though the deal was fulfilled. In this case, the arbitrator can compile the data from both parties, and release the cryptos associated with the transaction in the smart contract escrow to either the sender's blockchain address 338′ or the receiver's blockchain address 338. The arbitrator 334, 334′ communicates with the traders (users) through the web frontend. Since the crypto is locked in the escrow during any dispute, the only part in question is whether the payment was made or not. The seller is asked to provide proof of funds received, and the buyer is asked to provide proof of funds sent. The backend servers also track the reputation of each user based on number of successful trades (undisputed) and volume. With this data, the arbitrator can decide on to whom the funds should be released. Using the technology of the present invention, users are guaranteed that the funds cannot slip elsewhere. By design, the arbitrator's 334, 334′ role is only to be able to side with one side: buyer or seller. This keeps the system more secure from outside hacks trying to pull the funds out elsewhere. Specific payment methods such as PayPal, KakaoPay, WeChat Pay, and/or USDT settlement have nuances to check for that makes it easier to determine the source of truth. Arbitrators 334, 334′ in the present system know what to look for based on the payment method

The arbitrator 334, 334′ can never pull the funds out elsewhere and can make no impact on the transaction unless a dispute arises. The arbitrator 334, 334′ acts in the multi-signature address framework to determine whether to sign and validate the dispute identified by the buyer 332 or the seller 332′. The cryptocurrency is only transferred by the multi-signature escrow 336, 336′ if it can verify that two of the three signing keys are present on the transaction.

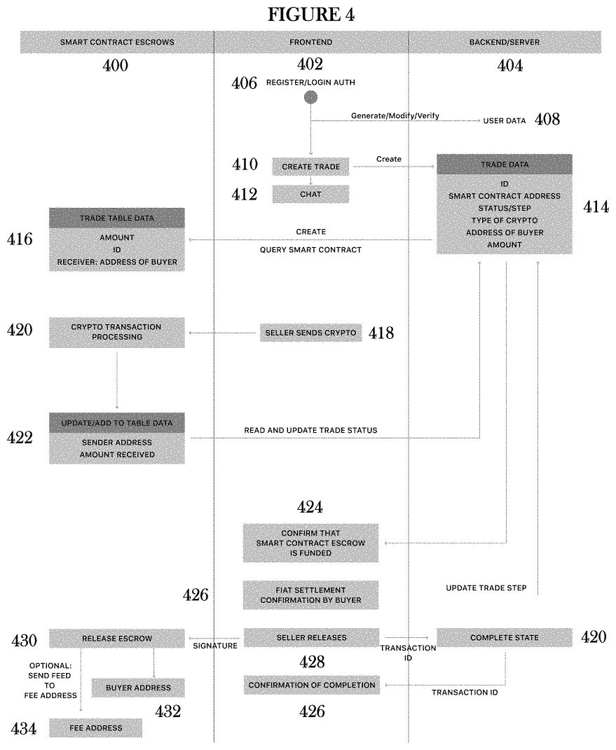

FIG. 4 shows an exemplary diagram of the system processes using smart contract escrows. The system processes are comprised of processes that occur at the smart contract escrow 400, at the front-end 402, and at the backend/server 404. A user can register or login 406 to the system at the front-end 402. The user can generate, modify, or verify user data 408, create a trade 410, or chat 412. If the user chooses to create a trade 410, then trade data 414 is generated, where the trade data 414 is comprised of the trade ID, the smart contract address, the status/step in the trade, the type of cryptocurrency used, the address of the buyer, and the amount of the trade. The user can create or query trade data 414 in the smart contracts using the trade table data 416, which comprises searches by trade amount, trade ID, and/or the address of the buyer.

Using the front-end 402, the user who is a seller can also send cryptocurrency associated with a transaction. The instruction to send the cryptocurrency is transmitted to crypto transaction processing 420, which can access and/or add to trade table data 422. The updating or adding to the trade table data 422 involves reading and updating the trade status using the previously entered trade data 414. Exemplarily, the sender address and the amount received may be added.

The trade data 414 is also used to confirm that the smart contract escrow is funded 424 at the frontend 402. The front-end 402 also tracks and receives fiat settlement confirmations by buyers 426. Tracking and receipt exemplarily work as follows. The buyer simply clicks a button to confirm that they paid. The front-end 402 then moves both buyer and seller to a new page, where seller is prompted to release escrow if they did indeed receive the funds. The buyer is prompted to wait until the seller releases the escrow. The buyer and the seller can continue to chat throughout the whole process through the front-end 402. The front-end 402 is also where the seller can release escrow or complete a trade 428. When the seller releases escrow 430, the buyer address 432 is notified that the transaction has occurred. Optionally, the transaction data is sent to the fee address 434. The fee address 434 may be used as a manner in which to generate revenue with the system. The system can collect a certain percentage from each trade's volume in crypto as the system/arbitrator's fees. That percentage could also be used to cover the costs of running the system's servers.

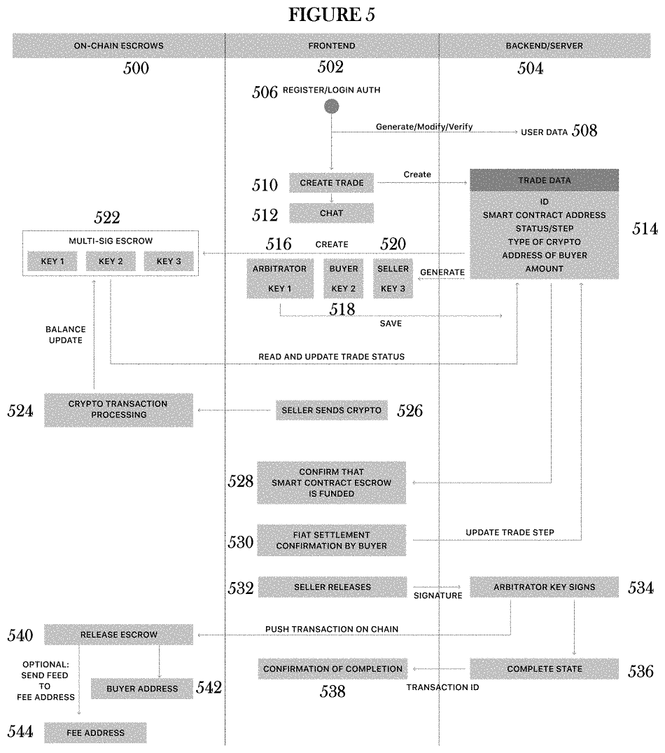

FIG. 5 shows an exemplary diagram of the system processes using multi-signature (on-chain) escrows. The system processes are comprised of processes that occur at the on-chain escrows 500, at the front-end 502, and at the backend/server 504. A user can register or login 506 to the system at the front-end 502. The user can generate, modify, or verify user data 508, create a trade 510, or chat 512. If the user chooses to create a trade 510, then trade data 514 is generated, where the trade data 514 is comprised of the trade ID, the smart contract address, the status/step in the trade, the type of cryptocurrency used, the address of the buyer, and the amount of the trade. At the front-end 502, the trade data 514 is used to create and assign signing keys for transactions. There are three keys: an arbitrator key 516, a buyer key 518, and a seller key 520. The multi-signature escrow module 522 verifies the three keys to validate and confirm the transactions in the system.

Exemplarily, the multi-signature escrow module 522 interacts with the crypto transaction processing module 524 when the seller sends cryptocurrency 526, resulting in an update to the balance on the transaction at the multi-signature escrow module 522 upon verification of at least two of the three signing keys. Crypto transaction processing at the crypto transaction processing module 524 indicates that the transaction (usually) take a bit of time to get confirmed by the validators of the blockchain network until the multi-signature escrow's address balance is fully updated. The multi-signature escrow module 522 also interacts with the trade data 514 to read and update trade status based on verified changes to the status of the transaction.

The trade data 514 is also used to confirm that the multi-signature escrow address is funded 528 at the frontend 502. The front-end 502 also tracks and receives fiat settlement confirmations by buyers 530, which results in an update to the trade status/step in the trade data 514. Tracking and receipt exemplarily work as follows. The buyer clicks a button to confirm that they paid. The frontend 502 then moves both buyer and seller to a new page, where seller is prompted to release escrow if they did indeed receive the funds. Buyer is prompted to wait until the seller releases the escrow. They can continue to chat throughout the whole process through the frontend 502. The front-end 502 is also where the seller can release escrow or complete a trade 532. When the seller releases escrow 532, the arbitrator key 534 is required to sign the transaction in order to reach the complete state 536 for the transaction. The front-end 502 is then transmitted a confirmation of completion 538 of the transaction. The confirmation of completion 538 of the transaction is preferably comprised of the transaction/trade ID. The signing of the arbitrator key 534 also results in pushing of the transaction to the on-chain escrow 500, which releases the escrow 540. When the escrow is released 540, the buyer address 542 is notified that the transaction has occurred. In the case where there is an attempt to release escrow, when the arbitrator key signs 534 is notified that the transaction has occurred.

Optionally, the transaction data is sent to the fee address 544. The fee address 544 may be used as a manner in which to generate revenue with the system. The system can collect a certain percentage from each trade's volume in crypto as the system/arbitrator's fees. That percentage could also be used to cover the costs of running the system's servers.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A system for transaction management comprised of:
a server comprising a smart contract module that receives a first set of transaction data corresponding to the financial transaction from a sender,
detects and verifies transaction terms from the first set of transaction data,
receives a second set of transaction data corresponding to the financial transaction from a receiver,
verifies that the first set of transaction data corresponds to the second set of transaction data, and
initiates the transfer of cryptocurrency associated with the financial transaction.

2. The system of claim 1, wherein the server further operates to settle disputes between the sender and the receiver involved in the financial transaction.

3. The system of claim 2, wherein the dispute to the financial transaction is initiated by the sender or the receiver.

4. The system of claim 1, wherein the first set of transaction data is comprised of a trade amount, a receiver address, and a trade ID.

5. The system of claim 1, wherein the financial transaction is an open trade, a release of escrow, a trade cancellation, or a refund request.

6. A computer-implemented method for transaction management comprising:
receiving a first set of transaction data corresponding to a financial transaction from a sender;
detecting and verifying transaction terms from the first set of transaction data;
receiving a second set of transaction data corresponding to the financial transaction from a receiver;
verifying that the first set of transaction data corresponds to the second set of transaction data; and
initiating the transfer of cryptocurrency associated with the financial transaction.

7. The method of claim 6, wherein the server further operates to settle disputes between the sender and the receiver involved in the financial transaction.

8. The method of claim 7, wherein the dispute to the financial transaction is initiated by the sender or the receiver.

9. The method of claim 6, wherein the first set of transaction data is comprised of a trade amount, a receiver address, and a trade ID.

10. The method of claim 6, wherein the financial transaction is an open trade, a release of escrow, a trade cancellation, or a refund request.

11. A system for transaction management comprised of:
a server comprised of:
a multi-signature address module that operates to settle disputes between a sender and a receiver involved in a financial transaction, wherein
the multi-signature address module receives a first set of transaction data corresponding to the financial transaction from a sender, wherein the first set of transaction data is comprised of a first signed key,
detects and verifies transaction terms from the first set of transaction data,
signs the verified transaction data with a second signed key, and
opens the financial transaction for processing,
wherein the server initiates the transfer to cryptocurrency associated with the open financial transaction.

12. The system of claim 11, wherein the financial transaction is an open trade, a release of escrow, a trade cancellation, or a refund request.

13. The system of claim 11, wherein the receiver has a second set of transaction data corresponding to the financial transaction, wherein the second set of transaction data is comprised of a third signed key, wherein the second set of transaction data is transmitted to the multi-signature address module.

14. The system of claim 13, wherein the dispute is settled by the multi-signature address module by signing either the first set of transaction data or the second set of transaction data.

15. The system of claim 15, wherein the system further outputs a confirmation of transaction completion.
